(19) United States
(12) Patent Application Publication
(10) Pub. No.: US 2015/0027721 A1
(43) Pub. Date: Jan. 29, 2015

(54) Method and apparatus for recovery of heat from throat of acting land volcano

(71) Applicants: Vladimir Anatol Shreider, Sydney (AU); Natalia Shreider, Sydney (AU)

(72) Inventors: Vladimir Anatol Shreider, Sydney (AU); Natalia Shreider, Sydney (AU)

(21) Appl. No.: 13/987,421

(22) Filed: Jul. 24, 2013

(51) Int. Cl. E21B 41/00; E21B 36/00

(52) U.S. Cl. CPC E21B 41/00; E21B 36/00
USPC 166/369; 166/57; 166/381

(57) ABSTRACT

Geothermal energy is recovered from magma via a vent of volcano by a longitudinally displaceable, closed system of one tube for injecting working condensed water and the other production tube for return of heated water, and a number of heating tube members connected to front portions of the tubes. The water may be assisted in its return by a pump. The tubes are capable to be advanced relative to a stationary shelter building by a drive means disposed securely at the vent. The front portions are articulated and/or flexible, and provided with a chassis. The tubes may be in co-axial relation and the outer injection tube is used as the heat economizer and insulator tube, and provided with sank and movable scraper members to remove a scale. A heat exchange means is operable to recover thermal energy from the water.

### CROSS-REFERENCE TO A RELATED APPLICATION

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

It is well-known that a source of very hot magma liquid, gas and flowing lava can be found at an active land volcano when it is erupting, at a relatively small height above the sea level. Such volcanos, the Italian Etna for example, are the most obvious, although perhaps the least amenable to exploitation.

The present invention relates to methods and embodiments for usage of heat energy of hot volcanic magma fluid in economy, more specifically to the methods for enhancing flow of geothermal heat from a magma fluid lake in a throat portion of conduit or vent of acting land volcano into a production means of a closed geothermal tube system, from which the heat can be conveyed to a consumer or exchanger in order to be used to produce power or for other purposes.

### TECHNICAL BACKGROUND OF THE INVENTION

It has been proposed to create in a hot geological strata a single borehole provided with a closed assembly of one tube which being used to supply a cold working water and the other used to return heated water. This certainly creates the needs to drill a borehole and an even bigger problem due to the absolute necessary to have a very efficient heat receptor and exchanger at the bottom of the borehole, since the heat must now be recovered from that relatively limited portion of the hot strata in the immediate vicinity of the end floor of the tube assembly. Where, for example, water is circulated through the latter using the single borehole system, the overall efficiency is quite low. It has been proposed that geothermal heat should be recovered by means of a passive heat pipe.

The nearest U.S. Pat. No. 4,644,750 proposes a borehole into which is inserted a heat pipe system containing a working heat carrier in the form of fluid, the heat pipe system comprising a closed assembly of two tubes in concentric relation, the inner tube has a relative small inner diameter for the return of working fluid to the vicinity of an underground zone of relative hot strata. The working fluid is preferably assisted in its return under gravity by means of a pump. The system includes heat exchange means operable to recover thermal energy from the heated working fluid. A third and outermost tube may be used to reduce heat losses, this third tube enclosing the two tubes over all but that part of their length which is in the zone of relatively hot strata. A method of recovering the geothermal heat that comprises the steps of: inserting a single closed tube assembly into a borehole extending from the surface into a zone of a relatively hot strata so that one end of the assembly is at or adjacent the surface and the other end is in the zone; providing a heat exchanger in operative contact with the upper end and introducing a quantity of a working fluid thereinto, followed by operating the heat exchanger to receive heat from the heated working fluid, characterized by the step of providing the assembly of two tubes disposed in concentric relation, the outer production tube having a lower portion and an end bottom adjacent to the zone and being used for the return of heated working fluid to the vicinity of the zone, and the inner injection tube having numerous small holes and a lower end orifice at the vicinity of the bottom. A problem appears due to the necessity to drill a borehole and have a heat exchanger at the bottom of the borehole, where water is circulated between the stationary tubes since the heat must now be recovered from that relatively limited small zone portion of the hot strata in the immediate vicinity of the bottom of the outer tube and overall efficiency of the recovery is quite low, as where as forming a scale on inner surface of the tubes, which worsens the heat transfer into the tubes.

There it is known a proposal of drilling horizontal radial wells into a land volcano, but there is difficulties to drill exactly into a narrow vent conduit of the volcano.

The above mentioned problems can be at least mitigated by a proposed now the geothermal energy recovery method utilizing a geothermal tube system which is partly inserted through a throat into a throat portion of vent conduit of active land volcano.

### SUMMARY OF THE INVENTION

In one aspect the present invention provides an apparatus for use in recovering geothermal heat from magma fluid which existing in a throat portion of a vent conduit of active volcano and having an elevated temperature; the apparatus comprising a horizontal, geothermal injection tube into which working fluid is injected, and a second, horizontal, geothermal production return tube from which heated working fluid issues; and a geothermal, heating tube means which is connected between and in consecutive order with the injection and production tubes; and means for producing a working fluid density difference and a pressure difference between an outlet of the injection tube, from which injected working fluid flows into the heating tube means, and an inlet of the production tube into which heated injected working fluid flows from the heating tube means, because of lesser density of the heated working fluid and the pressure difference between the end portions of the tubes.

In another aspect the invention provides a method of recovering geothermal heat from geological magma fluid through an open throat of volcano that having an elevated temperature; the method comprising:

a. Using a throat portion of a vent conduit of land volcano as the heating flue portion;

b. Using magma fluid as the heating fluid;

c. Inserting a closed front portion of a tube system which is in the form of disposed in consecutive order an injection tube, a heating tube means, and a production tube for the return of a working fluid, into a zone of relatively hot geological magma fluid at the throat portion through the throat from the surface, so that one end of the portion of the closed tube system is on or adjacent the surface and the other end is in the zone;

d. Providing a source of working fluid in operative contact with the one end of the injection tube, followed by

e. Using energy from the working fluid from the one end of the production tube.

The method further comprises the steps of:

providing the closed, magma heat recovery, working fluid-heating tube means at the throat portion through the open throat;

providing the horizontal, geothermal tube at the ground surface, which has a front tube portion, in relation to a direction of flow of working fluid, which is connected to the heating tube means and used as the injection tube;

injecting working fluid into the heating Tube assembly through the end portion of the injection tube, whereby the injected working fluid is heated;

providing the horizontal, geothermal tube at the ground surface, which is connected to the heating tube means and used as the production return tube;

operating drive means to advance the heating tube assembly with the parallel injection and production tubes in relation to framework means which supports and guides the tubes so as to transfer heat from geothermal magma fluid to working fluid in the production tube;

operating a heat exchange means to generate a working fluid density difference and a pressure difference between the injection outlet and the production inlet; and

inducing heated working fluid into the production geothermal tube from the geothermal heating tube means because of the density difference and the pressure difference between the injection tube portion and the production tube portion; and

increasing the pressure difference by pressuring the working fluid, injected in the outlet above the hydrostatic pressure existing at the depth of the outlet by using a working fluid pump connected to the injection tube so as to sink the heating tube assembly because of increasing the weight of working fluid in the end portion of the tube system.

The apparatus for enhancing the flow of geothermal heat to a production tube from a geological magma fluid through a throat of active land volcano, which comprises:

a. A first, horizontal, longitudinally displaceable, geothermal tube of a geothermal system, which is used as the injection tube into which working fluid is injected, wherein the injection tube has a front end tube portion meters and a closed outlet;

b. A second, horizontal, longitudinally displaceable, geothermal tube of the geothermal system, which is used as the production return tube from which heated working fluid issues,

wherein the production tube has a front tube portion and a closed inlet;

c. A closed, geothermal tube means of the system, which is used as the heating tube means,

wherein the tube means is connected between the injection outlet and the production inlet and displaceable with the injection and production tubes;

d. Means for producing a working fluid density difference and a pressure difference between the injection outlet and the production inlet, whereby injected working fluid flows into and through and out of the heating tube means because of the density difference and the pressure difference between the outlet and the inlet.

The apparatus comprises a framework means for supporting and guiding sections of the tube system with using a remote navigation system, which is disposed in an abutment shelter building, and drive means for effecting relative movement between the framework means and the heating tube means with the tube sections to effect thermal transfer to the working fluid from the geological fluid in the throat portion.

The heating tube means comprises a number of geothermal heating tubes of length more than 5 meters and lesser than 10 meters, and each of the heating tubes is connected with one its end to the injection outlet and with the other end to the production inlet of lengths more than 5 meters and lesser than 10 meters, and substantially radially spaced from the other adjacent tube by distances dependent on velocity of flow and temperature and viscosity of the geothermal magma liquid, and are equal to more than 0.2 and lesser than 0.3 meter. Walls of the heating tubes have superficial portions, which are extending along, inside and outside of the heating tubes, and have a width more than 0.2 and lesser than 0.3 meter and length more than 5 meter and lesser than 10 meters.

Numbers of short members having acute angular tops, which are placed in the heating tubes and the injection inlet and the production outlet, and used as the scraper members, and displaceable with flow of working fluid, and have sizes from more than 0.2 and lesser than 0.5 of a width of capillaries of the tubes.

The tubes are assembled into a co-axial tube assembly, and the outer tube of the assembly that is used as the heat economizing and insulation injection tube. The co-axial tube assembly comprises a number of co-axial tube sections connected in consecutive order with hinges having transversal and at least horizontal turning axes.

The co-axial tube assembly is bendable and flexible in radial directions and planes, in relation to the central longitudinal axis of the assembly, and comprises:

an outer tube which is twisted closely of a band and has a big inner capillary width; and

a number, preferably two, disposed co-axially, goffer tubes; and

a string member which is disposed axially and supported by its ends on end coupling flange means of the tube assembly; and

a plurality of distance spreader members which are arranged along the length on the string member.

The apparatus further comprises a chassis means for supporting and guiding the front portion of the tube system to facilitate advancement of the tube system to at the throat portion, the chassis means is used also as buoying chassis means for floatation of the heating tube means or as the plummeting chassis means for sinking of the heating tube means at magma liquid.

A heat exchanger means for producing a working fluid temperature and density difference and a pressure difference, which is capable of extracting heat directly from the heated working fluid in the production tube, and using the extracted heat for the production of energy, and comprises conduit means for conveying heated working fluid to an expansion chamber from the production tube, whereby the heated fluid is transferred to a working steam for producing power in an electricity generator and a steam turbine for driving the generator and the working fluid becoming heat-depleted, and conduit means for conveying heat-depleted fluid to a steam condenser from the turbine to produce condensed fluid, and for conveying condensate to a working fluid-injection pump and into the injection tube.

In a third aspect the invention provided a method for construction a geothermal assembly for recovering heat from a throat portion of vent conduit of active land volcano through the throat, the method

utilizing an abutment framework shelter building which is disposed at a path extending between a throat portion of a vent conduit of volcano containing geothermal magma fluid having an elevated temperature, and a remote by a distance dependent on the intensity of erupting of the volcano, heat exchange means, and comprises a framework means for supporting and guiding, with using a navigation means, the closed, tube portion of the geothermal system, and drive means for effecting displacement of the tube portion along the path and a working fluid-heating tube means of the tube portion into the throat portion, and comprising the steps of:

digging the path by means of excavating devices;

providing on the path the extensible, elongate, displaceable along the length of the path, tube portion of the geothermal system for recovering heat from a geological magma fluid existing at the throat portion and having an elevated temperature, the tube portion is composed of:

adjacent in end-by-end order, tube sections of a first, horizontal, extensible, geothermal tube which is used as the injection tube into which working fluid is injected; and

adjacent in end-by-end order, tube sections of a second, horizontal, extensible, geothermal tube which is used as the production return tube from which heated working fluid issues to the exchange means, and

a geothermal tube means which is used as the working fluid-heating tube means and connected between end tube portions of the injection and production tubes in consecutive order and operative contact with the heat exchange means;

operating the drive means to advance the tube portion of the system along the path in relation to the abutment framework building which supports and guides with using a navigation means the heating tube means and the tube sections so as the tube means to insert at the throat portion.

The method is characterized by the steps of:

using the front end tube portion which is movable in at least vertical plane about follower portions of the front tube assembly, to facilitate advancement of the front end portion on a broken country slope and to the throat of the volcano, and ascendment of the front portion out of the throat by a pressure of a natural erupting outflow of magma liquid to prevent destruction of the front end portion;

generating distances between the heating tube means and walls of the throat portion, which are dependent on a rate of outflow of magma fluid, optionally to improve the thermal transfer to working fluid in the tube means from magma fluid at the throat portion;

providing a chassis means for supporting and guiding the heating tube means to facilitate advancement of the tube assembly and the end tube portions of the injection and production tubes relative to the framework building and to at the throat portion, which is used as buoyage or plummeting chassis means in magma liquid at the throat portion; as well as by the intermediate steps of:

providing the shelter building having a rear entrance opening and an exit opening which are generally surrounding the tube sections of the front tube portion of the geothermal recovery system when that approaching from the lower slope and extending to the throat from the building, and sealing means at the openings for engaging on the tube section previously installed and reassembled to close off the interior of the building in relation to its exterior and prevent the ingress of volcanic fluid materials into the building from the volcanic surroundings; and an injection pressure ventilation means in operative contact through an air channel with a source of conditioned air, where the drive means are activating to:

place the tube sections in turn through the entrance opening into the building,

disassemble the sections from the rear tube portion when which have been approached the building;

turn the disassembled sections in horizontal and vertical planes to be oriented in a direction toward the throat, and

reassemble the sections in end-by-end order into the front portion of the tube portion of the system, and

further operating the drive ram means to advance the heating tube means with the extensible, parallel front portions of the injection and production tubes through the front opening to at the throat portion, in relation to the framework building which supports and guides the heating tube means and the tube portions using cosmic satellites-supported navigation system, and simultaneously

reconnect together in end-to-end relation the tube portions which are on the path to the framework means and the extensible tube portions into operative contact with the heat exchange means; and

inject working fluid into the reconnected injection tube so as to heat the working fluid in the heating tube means, recover heated working fluid from the heating tube means and the production tube, extract heat from the recovered fluid, and use; and

providing heat exchange and recovery means having a working fluid gas-expansion chamber which is connected to the production tube and an expanded gas turbine/alternator assembly to produce electricity and heat-depleted gas, and to a heat-depleted gas-condenser means to produce condensed, heat-depleted fluid and a pump for pumping the heat-depleted fluid which is used as the working condensed fluid into the injection tube, and operating the pump to float and sink the front end tube portion of the system in the zone in relation to magma liquid which supports the front end tube portion so as to displace the portion in relation to magma liquid at the throat portion and improve heat transfer to working fluid from magma liquid

The invention may be more fully and readily understood and various other features of the invention may become more apparent from consideration by referring to the following detailed description and specification in connection with the appended drawings.

### BRIEF DESCRIPTION OF THE DRAWINGS

A description of the present inventive subject matter including embodiments thereof is presented and with reference to the accompanying drawings, the description not meaning to be considered limiting in any manner, wherein:

FIG. 1 is a view illustrating the first step of the construction method with using the embodiment of the apparatus according to the invention;

FIG. 2 is a schematic representation of a side view of the embodiment shown in FIG. 1 in the working position according to the invention;

FIG. 3 is a schematic representation of a side view of the embodiment shown in FIG. 1 in further working positions according to the invention;

FIG. 4 is the schematic representation of a side view of another embodiment of the apparatus in the working position according to the invention;

FIG. 5 is a side view illustrating on an enlarged scale relative to FIGS. 1-3 one embodiment of the working fluid-heating tube means according to the invention;

FIG. 6 is a side view illustrating on an enlarged scale relative to FIG. 4 another embodiment of the working fluid-heating tube means according to the invention;

FIG. 7 is an axial sectional view on an enlarged scale relative to FIG. 6 of the heating tube provided with the heating wall portion and the scraper members according to the invention;

FIG. 8 is a cross-sectional view of the tube, wall portion shown in FIG. 7;

FIG. 9 is a partly axial sectional view on an enlarged scale relative to FIG. 4 of the flexible, co-axial tube assembly according to the invention.

Similar reference numbers and designations in the various Figs. refer to like elements.

### DETAILED DESCRIPTION OF PREFERRED EMBODIMENTS

In order to that invention be better understood, and referring to FIG. 1, the installation may be conveniently described in terms of two portions, one at the surface of the volcanic ground 1 at the land mount volcano 2, and the other at below of an open throat 3 of a throat portion 4 of geological vent conduit containing magma liquid 5 and adjacent from above gas and heat radiation 6 having an elevated temperature. Liquid and gas are capable of pouring upward and out of the throat portion and flowing at above the lowest ridge portion 7 of a side slope of the volcano as it is shown by an arrow in FIG. 7.

In the embodiment of FIG. 1, the apparatus for enhancing the flow of geothermal heat to a production tube from a geological magma fluid through a throat of active land volcano, which comprises:

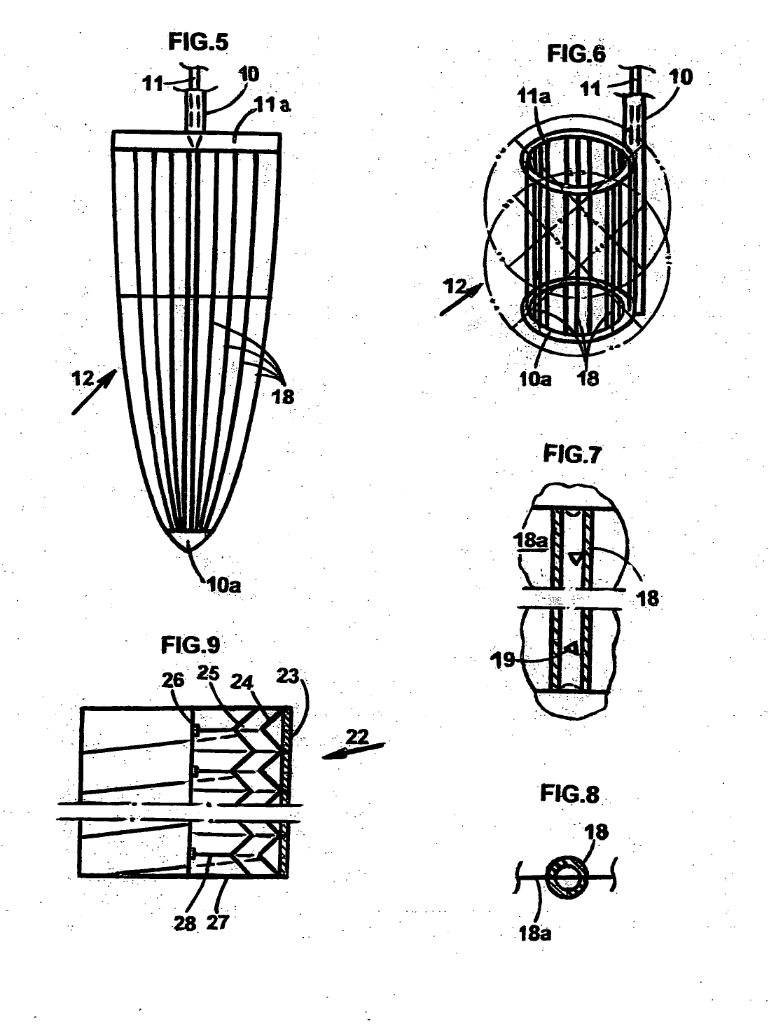

a. A first, horizontal, longitudinally displaceable, geothermal tube 10 of a geothermal tube system (as shown in FIG. 1), which is used as the injection tube into which working fluid is injected, and has a front end tube portion 10 a and a closed outlet 10b (as shown in FIGS. 5 and 6);

b. A second, horizontal, longitudinally displaceable, geothermal tube 11 of the geothermal tube system (as shown in FIG. 1), which is used as the production tube from which heated working fluid issues, and has a front tube portion 11a and a closed inlet 11b (as shown in FIGS. 5 and 6);

c. A closed, geothermal tube means 12 of the tube system (as shown in FIG. 5), which is used as the heating tube means, and connected between the injection outlet and the production inlet and displaceable with the injection and production tubes;

d. Means 13 (as shown in FIG. 1) for producing a working fluid density difference and a pressure difference between the injection outlet and the production inlet, whereby injected working fluid flows into and through and out of the heating tube means because of the density difference and the pressure difference between the outlet and the inlet.

The injection and production tubes have lengths up to 5.0 kilometers. The tube means has height and width up to 3 meters, and a length up to 10 meters, and can be floatable to improve heat transfer to the heating tube means from the geothermal fluid having an unstable surface, or sinkable in geothermal magma liquid having a stable surface to improve burying of the tube means and heat transfer to the tube means from the liquid.

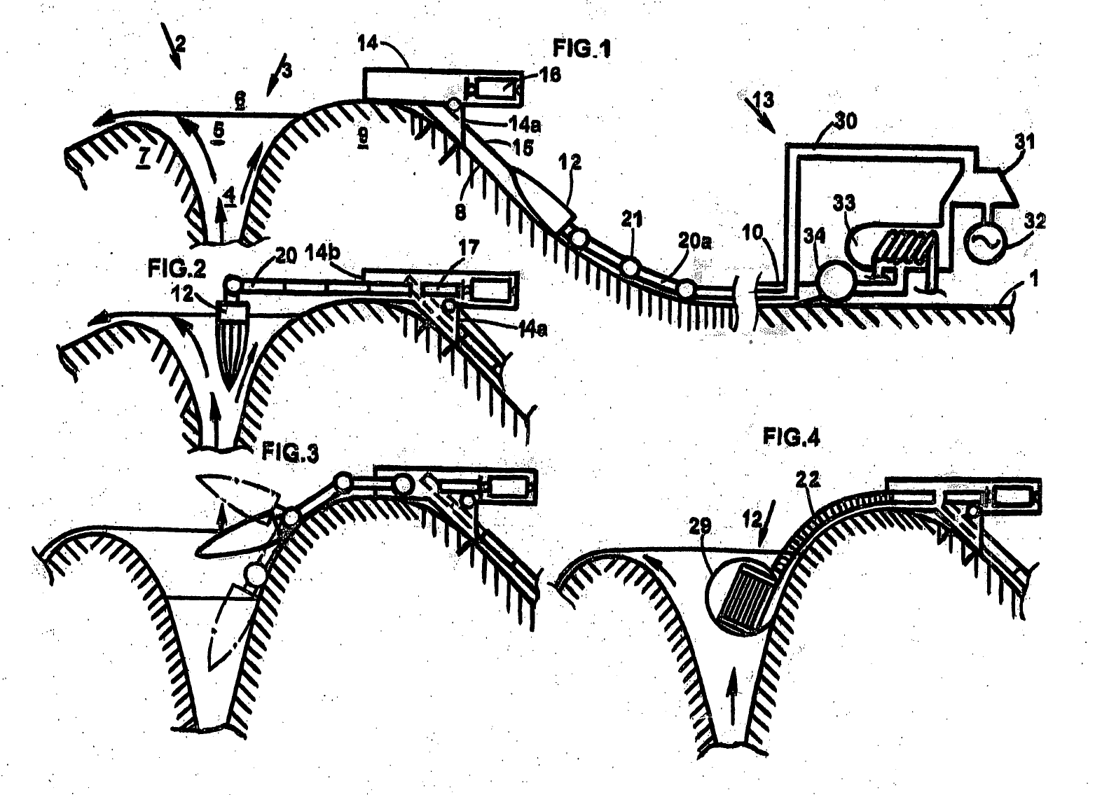

The apparatus further comprises a framework means for supporting and guiding sections of the tube system with using the Global Positioning System, for example, which is disposed in an abutment shelter building 14 (as shown in FIG. 1), and a drive winch means 15 and a drive ram means 16 for effecting relative movement between the framework means and the heating tube means with the injection and production tube sections 17 (as shown in FIG. 2) of a length up to 6 meters, for instance, to effect thermal transfer to the working fluid from the geological fluid in the throat portion. The extensible, horizontal, geothermal portions of the injection and production tubes which extending to the throat from the building, have lengths up to 1.0 kilometer.

The heating tube means comprises a number of geothermal heating tubes 18 (as shown in FIGS. 5-8) of length more than 5 meters and lesser than 10 meters, and each of the heating tubes is connected with one its end to the injection outlet and with the other end to the production inlet, and substantially radially spaced from the other adjacent tube by distances dependent on velocity of flow and temperature and viscosity of the geothermal magma liquid, and are equal to more than 0.2 and lesser than 0.5 meter. The heating tubes have superficial portions 18a, which are extending along, inside and outside of the heating tubes, and have a width equal to 0.2-0.3 meter and length equal to 5-10 meters. Numbers of short members 19 (as shown in FIG. 7) shaped into tetrahedrons and cubes, for instance, and having acute angular tops, which are placed in the heating tubes and the injection inlet and the production outlet, and used as the scraper members, and displaceable with flow of working fluid, and have sizes from more than 0.2 and lesser than 0.5 of a width of capillaries of the heating tubes.

The injection and production tubes which are assembled into co-axial tube assembly 20 of the sections 17 (FIG. 2), the outer injection tube of the assembly that is used as the heat economizing and insulation injection tube. The tube assembly can comprise a number of co-axial tube sections 20a connected in consecutive order with hinge means 21 having common transversal and at least horizontal turning axes.

The embodiment 22 of the co-axial tube assembly can be bendable and flexible in radial directions and planes, in relation to the central longitudinal axis of the assembly, and comprises (as shown in FIG. 9):

an outer tube 23 which is spirally and closely twisted of a band and has a big inner capillary width; and

a number, preferably two, disposed co-axially, an outer goffer tube 24 which is used as the injection tube and an inner goffer tube 25 which is used as the production tube; and

a string member 26 which is disposed axially and supported by its ends on end coupling flange means 27 of the flexible tube assembly; and

a plurality of distance spreader members 28 which are arranged along the length on the string member.

The heating tube means is provided with a chassis means for supporting and guiding the front end portion of the tube system to improve displacement of the tube system along the path and to the throat portion, which are used also as the buoy or plummet chassis means for the heating tube means. The chassis means comprises a number of self-adjustable wheels 29 having horizontal and transversal axes and diameters 2-5 meters, and a gauge 1.5-2.0 meter. The heating tubes 18 of the conic-shaped heating tube means 12 (as shown in FIG. 1) are capable to be used as the ski chassis means. The chassis means is used also as the buoying chassis means for floatation of the heating tube means or as the plummeting chassis means for sinking of the heating tube means at magma liquid (as shown in FIGS. 2-4).

The heat exchanger means 13 (as shown in FIG. 1) comprises conduit means 30 for conveying heated working fluid to a working gas-expansion chamber 31 from the production tube, whereby the heated fluid is transferred to a working steam for producing power in a steam turbine and electricity generator means 32 and the working fluid becoming heat-depleted, and conduit means for conveying heat-depleted fluid to a steam condenser means 33 from the turbine to produce condensed fluid, and for conveying condensate to a working fluid-injection pump 34 and into the injection tube.

The apparatus further comprises instrumentation for remote monitoring working positions of the front end portion of the tube system at the throat portion, and the pressure difference and the temperature of working fluid.

Generally, the method of recovering geothermal heat from geothermal magma fluid through an open throat 3 of an active land volcano 2 comprises the following steps of:

a. Using a throat portion 4 of a vent conduit of the volcano as the heating flue portion;

b. Using magma liquid 5 and gas 6 as the heating fluid;

c. Inserting a closed front portion of a geothermal heat recovery tube system which is in the form of disposed in consecutive order an injection tube 10, a heating tube means 12, and a production tube 11 for the return of working fluid, into a zone of relatively hot geological magma fluid 5 and 6 at the throat portion through the throat from the ground surface 1, so that one ends of the injection and production tubes are in or adjacent the ground surface and the other ends and the heating tube means are in the zone at magma fluid;

d. Providing a source of working fluid, such as a heat exchange means 13, in operative contact with the one ends of the injection and production tubes, followed by

e. Operating the heat exchange means to recover energy from working fluid in the production tube.

More detailed, the method comprises the steps of:

providing the closed, magma heat recovery, working fluid-heating tube means at the throat portion through the open throat;

providing the horizontal, geothermal injection tube at the ground surface, which has a front tube portion, in relation to a direction of flow of working fluid, which is connected to the heating tube means;

injecting working fluid into the heating tube means through the end portion of the injection tube, whereby the injected working fluid is heated;

providing the horizontal, geothermal production tube at the ground surface, which is connected to the heating tube means;

operating drive winch means 15 and/or drive ram means 16 to advance the heating tube means with the parallel injection and production tubes in relation to a framework means 14 which supports and guides the tubes using The Global Positioning System, for instance, so as to transfer heat from geothermal magma fluid to working fluid in the production tube;

operating the exchange means to generate a working fluid density difference and a pressure difference between the injection outlet and the production inlet; and

inducing heated working fluid into the production geothermal tube from the geothermal heating tube means because of the density difference and the pressure difference between the injection tube end portion and the production tube end portion.

The method further comprises the further step of

increasing the pressure difference by pressuring the working fluid, injected in the outlet above the hydrostatic pressure existing at the depth of the outlet by using a working fluid pump 33 connected to the injection tube so as to sink the heating tube means because of increasing the weight of working fluid in the end portion of the tube system, which is at the throat portion, and improve the thermal transfer to the working fluid from the geological fluid.

The method for construction a geothermal assembly for recovering heat from a throat portion of vent conduit of active land volcano, the method

utilizing an abutment framework shelter building 14 which is disposed at a path extending between a throat 3 of a vet conduit of a volcano 2 and a heat exchange means 13 which is located remote by a distance dependent on the intensity of erupting of the volcano, and comprises the framework means (not shown) for supporting and guiding, with using a positioning system such as the GPS, a longitudinally displaceable tube system including a working fluid-heating tube means 12 and an injection and production tube assembly 20, and a drive winch means 15 and a drive ram means 16 for effecting displacement of the tube system along the path into the throat portion 4 through the throat 3, and comprising the steps of:

digging the path by means of excavating devices;

providing on the path an extensible, elongate, displaceable along the length of the path, tube portion of the geothermal tube system for recovering heat from a geological magma fluid existing at the throat portion and having an elevated temperature, the tube portion is composed of:

adjacent in end-by-end order, tube sections of the first, horizontal, extensible, geothermal tube 10 which is used as the injection tube into which working fluid is injected; and

adjacent in end-by-end order, tube sections of a second, horizontal, extensible, geothermal tube 11 which is used as the production tube from which heated working fluid issues to the exchange means 13, and

a geothermal tube means 12 which is used as the working fluid-heating tube means and connected between an injection outlet 10a of the injection tube 10 and an production inlet 11a of the injection tube 11 in consecutive order and operative contact with the exchange means 13;

operating the drive winch means 15 to advance the extensible tube system along the path in relation to the framework building 14 which supports and guides with using a positioning system such as the GPS the heating tube means 12 with sections of the injection and production tubes so as to insert the tube means 12 at the throat portion 4 through the throat 3.

The suitability of a slope 8 and a relatively high ridge portion 9 and the throat portion 4 of the volcano 2 that is determined by geophysical surveys, and air photography's from drones and/or cosmic photography's from satellites, and direct reconnaissance from the building 14 which is spaced by a safe but short distance from the throat and provided with vision devices for surveillance (not shown).

The method is characterized by the further steps of:

using the front end tube portion which is composed of the heating tube means 12 and the front portions of the injection and production tubes 10 and 11 or the co-axial tube assembly 20 or 22 and movable in at least vertical plane about follower portions of the front tube portions, to facilitate advancement of the front end tube portion on the broken country slope 8 and the ridge portion 9 to the throat 3, and ascendment of the front portion out of the throat by a pressure of a natural erupting outflow of magma liquid to prevent destruction of the front end portion;

generating distances between the heating tube means 12 and walls of the throat portion, which are dependent on a rate of outflow of magma fluid, optionally to improve the thermal transfer to working fluid in the tube means from magma fluid at the throat portion;

providing the chassis means 29 for supporting and guiding the tube means to facilitate advancement of the tube means 12 and the end tube portions of the injection and production tubes relative to the framework building 14 and to at the throat portion 4, which is used as buoyage or plummeting chassis means in magma liquid at the throat portion; and by the intermediate steps of:

providing in the shelter building 14 a rear entrance opening 14a and a front exit opening 14b which are generally surrounding the tube sections 20a when that are approaching from the slope 8 and extending to the throat 3 from the building, and sealing curtain means (not shown) at the openings for engaging on the tube section previously installed and reassembled to close off the interior of the building in relation to its exterior and prevent the ingress of volcanic fluid materials into the building from the volcanic surroundings; and an injection pressure ventilation means in operative contact through an air channel with a source of conditioned air (not shown), where

the drive winch means 15 is operating to advance the tube sections in turn through the entrance opening into the building,

disassemble the sections from the rear tube portion which is on the slope, when the sections have been approached the interior of the building;

turn the disassembled sections in horizontal and vertical planes to be oriented in a direction toward the throat, and

reassemble the sections in end-by-end order into the front tube portion of the system, and

operating the drive ram means 16 to further advance the heating tube means with the extensible, parallel front portions of the injection and production tubes through the exit opening 14b to at the throat portion, in relation to the framework building which supports and guides the heating tube means and the tube portions using vision devices {not shown} and positioning system, and simultaneously

reconnect together in end-to-end relation the tube portions which are on the path to the framework means and the extensible tube portions into operative contact with the heat exchange means, and

inject working fluid into the reconnected injection tube so as to heat the working fluid in the heating tube means, recover heated working fluid from the heating tube means and the production tube, extract heat from the recovered fluid, and use extracted heat.

At last, the method is further characterized by the steps of extracting heat from the heated working fluid recovered from the production tube by the exchange means and using the extracted heat for the production of energy:

providing heat exchange and recovery means having a working fluid gas-expansion chamber 31 which is connected to the production tube and the expanded gas turbine/alternator assembly 32 to produce electricity and heat-depleted gas and injected fluid which is water condensate of the working water steam, and to the heat-depleted gas-condenser means 33 to produce condensed, heat-depleted fluid and to the pump 34 for pumping the heat-depleted fluid which is used as the working condensed fluid into the injection tube. The pump 34 is operated to float and sink the heating tube means 12 in relation to the magma liquid zone which supports the front end tube portion in the throat portion so as to displace the heating tubes in relation to magma liquid at the zone and improve heat transfer to working fluid from magma liquid.

The method comprises determining the suitability of the geological throat portion of the vent conduit of the volcano and geological magma fluid existing in the portion and having an elevated temperature. The suitability of the slope and ridge surface and the throat conduit portion is determined by geophysical surveys, and photography's from drones and cosmic satellites, and direct reconnaissance with using a shelter building which is spaced by a safe distance from the throat and provided with vision devices for direct and aero surveillance.

The methods and apparatus are especially useful at relatively low and small volcanos and collateral parts of relatively big volcanos which are acting uninterruptedly and long time, having the gentle slopes, the low and small ridge and a lake of magma liquid located at a shallow depth, in relation to the ridge, and located nearly to customers of energy. The advantages and improved results achieved by the methods and apparatus of the present invention are apparent from the description of preferred embodiments of the invention. Various changes and modifications may be made without departing from the spirit of the invention and without exceeding the scope of the claims.

We claim as our invention:

1. Method of recovering geothermal heat from an open throat of an active volcano, comprising the following steps of:
a. Using a throat portion of a vent conduit of land volcano as the heating flue portion;
b. Using magma fluid as the heating fluid;
c. Inserting a closed front portion of a geothermal heat recovery tube system which is in the form of disposed in consecutive order an injection tube, a heating tube means, and a production tube for the return of a working fluid, into a zone of relatively hot geological magma fluid at the throat portion through the throat from the surface, so that one ends of the injection and production tubes are in or adjacent the surface and the other ends and the heating tube means is in the zone;
d. Providing a source of working fluid in operative contact with the one end of the injection tube, followed by
e. Using energy from the working fluid from the one end of the production tube.

2. Method according to claim 1, comprising the steps of:
providing the closed, magma heat recovery, working fluid-heating tube means at the throat portion through the open throat;
providing the horizontal, geothermal tube at the ground surface, which has a front tube portion, in relation to a direction of flow of working fluid, which is connected to the heating tube means and used as the injection tube;
injecting working fluid into the heating tube assembly through the end portion of the injection tube, whereby the injected working fluid is heated;
providing the horizontal, geothermal tube at the ground surface, which is connected to the heating tube means and used as the production return tube;
operating drive means to advance the heating tube assembly with the parallel injection and production tubes in relation to framework means which supports and guides the tubes so as to transfer heat from geothermal magma fluid to working fluid in the production tube;
operating a heat exchange means to generate a working fluid density difference and a pressure difference between the injection outlet and the production inlet; and
inducing heated working fluid into the production geothermal tube from the geothermal heating tube means because of the density difference and the pressure difference between the injection tube portion and the production tube portion.

3. Method according to claim 2 comprising increasing the pressure difference by pressuring the working fluid, injected in the outlet above the hydrostatic pressure existing at the depth of the outlet by using a working fluid pump connected to the injection tube so as to sink the heating tube assembly because of increasing the weight of working fluid in the end portion of the tube system, which is at the throat portion.

4. Apparatus for enhancing the flow of geothermal heat to a production tube from a geological magma fluid through a throat of active land volcano, which comprises:
a. A first, horizontal, longitudinally displaceable, geothermal tube of a geothermal system, which is used as the injection tube into which working fluid is injected, wherein the injection tube has a front end tube portion meters and a closed outlet;
b. A second, horizontal, longitudinally displaceable, geothermal tube of the geothermal system, which is used as the production tube from which heated working fluid issues,
wherein the production tube has a front tube portion and a closed inlet;
c. A closed, geothermal tube means of the system, which is used as the heating tube means,
wherein the tube means is connected between the injection outlet and the production inlet and displaceable with the injection and production tubes;
d. Means for producing a working fluid density difference and a pressure difference between the injection outlet and the production inlet, whereby injected working fluid flows into and through and out of the heating tube means because of the density difference and the pressure difference between the outlet and the inlet.

5. Apparatus according to claim 4 and comprising a framework means for supporting and guiding sections of the movable geothermal portion of tube system of a length up to 5 kilometers with using a positioning system such as the GPS, which is disposed in an abutment shelter building, and drive means for effecting relative movement between the framework means and the heating tube means with the tube sections to effect thermal transfer to the working fluid from the geological fluid in the throat portion.

6. Apparatus according to claim 4, wherein the heating tube means comprises a number of geothermal heating tubes of length more than 5 meters and lesser than 10 meters, and each of the heating tubes is connected with one its end to the injection outlet and with the other end to the production inlet of lengths more than 5 meters and lesser than 10 meters, and substantially radially spaced from the other adjacent tube by distances dependent on velocity of flow and temperature and viscosity of the geothermal magma liquid, and are equal to more than 0.3 and lesser than 0.5 meter.

7. Apparatus according to claim 6, wherein walls of the heating tubes have superficial portions, which are extending along, inside and outside of the heating tubes, and have a width more than 0.2 and lesser than 0.3 meter and length more than 5 meter and lesser than 10 meters.

8. Apparatus according to claim 6, wherein numbers of short members having acute angular tops, which are placed in the heating tubes and the injection inlet and the production outlet, and used as the scraper members, and displaceable with flow of working fluid, and have sizes from more than 0.2 and lesser than 0.5 of a width of capillaries of the tubes.

9. Apparatus according to claim 6, and comprising the tubes, which are assembled into a co-axial tube assembly,
wherein the outer tube of the assembly that is used as the heat economizing and insulation injection tube.

10. Apparatus according to claim 9, wherein the co-axial tube assembly comprises a number of co-axial tube sections connected in consecutive order with hinge means having transversal and at least horizontal turning axes.

11. Apparatus according to claim 9, wherein the co-axial tube assembly is bendable and flexible in radial directions and planes, in relation to the central longitudinal axis of the assembly, and comprises:
an outer tube which is twisted closely of a band and has a big inner capillary width; and
a number, preferably two, disposed co-axially, goffer tubes; and
a string member which is disposed axially and supported by its ends on end coupling flange means of the tube assembly; and
a plurality of distance spreader members which are arranged along the length on the string member.

12. Apparatus according to claim 4, and comprising a chassis means for supporting and guiding the heating tube means to facilitate advancement of the tube system to at the throat portion,
wherein the chassis means is used also as buoying chassis means for floatation of the heating tube means or as the plummeting chassis means for sinking of the heating tube means at magma liquid.

13. Apparatus according to claim 4, and comprising a heat exchanger means for producing a working fluid temperature and density difference and a pressure difference, which is capable of extracting heat directly from the heated working fluid in the production tube, and using the extracted heat for the production of energy, and comprises conduit means for conveying heated working fluid to an expansion chamber from the production tube, whereby the heated fluid is transferred to a working steam for producing power in an electricity generator and a steam turbine for driving the generator and the working fluid becoming heat-depleted, and conduit means for conveying heat-depleted fluid to a steam condenser from the turbine to produce condensed fluid, and for conveying condensate to a working fluid-injection pump and into the injection tube.

14. Method for construction a geothermal assembly for recovering heat from a throat portion of vent conduit of active land volcano, wherein the method
utilizing an abutment framework shelter building which is disposed at a path extending between a throat portion of a vent conduit of volcano containing geothermal magma fluid having an elevated temperature, and a remote by a distance dependent on the intensity of erupting of the volcano, heat exchange means, and comprises a framework means for supporting and guiding, with using a navigation means, the closed, tube portion of the geothermal system, and drive means for effecting displacement of the tube portion along the path and a working fluid-heating tube means of the tube portion into the throat portion, and comprising the steps of:
digging the path by means of excavating devices;
providing on the path the extensible, elongate, displaceable along the length of the path, tube portion of the geothermal system for recovering heat from a geological magma fluid existing at the throat portion and having an elevated temperature, the tube portion is composed of:
adjacent in end-by-end order, tube sections of a first, horizontal, extensible, geothermal tube which is used as the injection tube into which working fluid is injected; and
adjacent in end-by-end order, tube sections of a second, horizontal, extensible, geothermal tube which is used as the production tube from which heated working fluid issues to the exchange means, and
a geothermal tube means which is used as the working fluid-tube means and connected between end tube portions of the injection and production tubes in consecutive order and operative contact with the heat exchange means;
operating the drive means to advance the tube portion of the system along the path in relation to the abutment framework building which supports and guides with using a navigation means the heating tube means and the tube sections so as the tube means to insert at the throat portion.

15. Method according to claim 14, characterized by the step of
using the front end tube portion which is movable in at least vertical plane about follower front tube portions, to facilitate advancement of the front tube portion on a broken country slope and a ridge of volcano to the throat, and ascendment of the front end portion out of the throat by a pressure of a natural erupting outflow of magma liquid to prevent destruction of the front end portion.

16. Method according to claim 14, further characterized by the step of
generating distances between the heating tube means and walls of the throat portion, which are dependent on a rate of outflow of magma fluid, optionally to improve the thermal transfer to working fluid in the tube means from magma fluid at the throat portion.

17. Method according to claim 16, characterized by the steps of
providing a chassis means for supporting and guiding the heating tube means to facilitate advancement of the tube assembly and the end tube portions of the injection and production tubes relative to the framework building and to at the throat portion, which is used as buoyage or plummeting chassis means in magma liquid at the throat portion.

18. The method of claim 14, characterized by the intermediate steps of:
providing the shelter building having a rear entrance opening and an exit opening which are generally surrounding the tube sections of the front tube portion of the geothermal recovery system when that approaching from the lower slope and extending to the throat from the building, and sealing means at the openings for engaging on the tube section previously installed and reassembled to close off the interior of the building in relation to its exterior and prevent the ingress of volcanic fluid materials into the building from the volcanic surroundings; and an injection pressure ventilation means in operative contact through an air channel with a source of conditioned air, where:
operating a drive winch means to advance the tube sections in turn through the entrance opening into the building,
operating a drive crane means to disassemble the sections from the rear tube portion when which have been approached the building; and
turn the disassembled sections in horizontal and vertical planes to be oriented in a direction toward the throat, and
reassemble the sections in end-by-end order into the front portion of the tube portion of the system, and
operating a drive ram means to advance the heating tube means with the extensible, parallel front portions of the injection and production tubes through the front opening to at the throat portion, in relation to the framework building which supports and guides the heating tube means and the tube portions using cosmic satellites-supported navigation system, and simultaneously
reconnect together in end-to-end relation the tube portions which are on the path to the framework means and the extensible tube portions into operative contact with the heat exchange means, and
inject working fluid into the reconnected injection tube so as to heat the working fluid in the heating tube means, recover heated working fluid from the heating tube means and the production tube, extract heat from the recovered fluid, and use.

19. Method according to claim 14, further characterized by the steps of:
providing heat exchange and recovery means having a working fluid gas-expansion chamber which is connected to the production tube and an expanded gas turbine/alternator assembly to produce electricity and heat-depleted gas, and to a heat-depleted gas-condenser means to produce condensed, heat-depleted fluid and a pump for pumping the heat-depleted fluid which is used as the working condensed fluid into the injection tube.

20. Method according to claim 19, further characterized by the step of
operating the pump to move the front end tube portion in the zone in vertical directions in relation to magma liquid which supports the front end tube portion so as to improve heat transfer to working fluid from magma liquid.
